(19) United States
(12) Patent Application Publication
(10) Pub. No.: US 2003/0014270 A1
(43) Pub. Date: Jan. 16, 2003

(54) Supply chain management system, computer product and method with data exchange means

(76) Inventors: Latiq J. Qureshi, Mississauga (CA); John S. Magalhaes, Mississauga (CA); Steve Moro, Maple (CA)

Correspondence Address: KEYSER MASON BALL, LLP, 201 CITY CENTRE DRIVE, SUITE 701, MISSISSAUGA, ONTARIO, ON, L5B 2T4, CA

(21) Appl. No.: 09/904,605

(22) Filed: Jul. 16, 2001

(51) Int. Cl. G06F 17/60

(52) U.S. Cl. 705/1

(57) ABSTRACT

A supply chain management system and computer product includes a data exchange means. The date exchange means consists of an integrated application repository providing data mapping, data translation and data transaction regardless of the electronic format of data received by the data exchange means. A method of deploying supply chain management between a plurality of users is also provided wherein a plurality of users are provided with supply chain management without migrating to new electronic formats of data and/or without implementation of additional data translation by the plurality of users.

### FIELD OF THE INVENTION

This invention relates in general to a system, computer product and method of conducting business electronically through an interconnected network of computers. This invention also relates in general to a flexible computer system architecture directed at transacting business electronically via an interconnected network of computers. This invention relates more particularly to an e-commerce system, computer product and method for creating an electronic community for conducting electronic transactions via an interconnected network of computers.

### BACKGROUND OF THE INVENTION

Since the advent of interconnected networks of computers such as the Internet, numerous inventions have been directed at providing systems, software and methods for taking advantage of the efficiencies of conducting business via electronic transactions rather than paper transactions.

Numerous such prior art systems, software and methods are directed at providing Value Added Networks, or VANs, comprising interconnected networks of computers providing the system infrastructure required to process data in electronic format for transacting business electronically. The implementation of such prior art solutions requires significant infrastructure investments and/or payment of network fees to VAN providers. Further, such prior art solutions are generally designed to recognize and interpret specific batches of data in electronic format or electronic transactions, whereas numerous electronic trading partners' own computer systems may not be able to recognize and interpret the same batches of data in electronic format or electronic transactions. Thus, such prior art solutions generally require the acquisition and implementation of translation utilities that translate electronic transaction data from one electronic format to another. The need for such translation utilities further increases the cost of such prior art solutions, as well as the complexity of such solutions overall. The greater complexity in turn increases the likelihood of processing errors, and also, more significantly, increases the time and cost required to implement such prior art solutions, particularly where a relatively significant number of electronic trading partners wish to transact business electronically.

Examples of this type of prior art solutions include solutions currently provided by VAN providers such as Sterling Commerce. Such prior art VAN solutions require the electronic trading partners to use their proprietary network. The data which flows through the VAN, however, is generally not in a format understood by the systems of the various electronic trading partners. This means a significant reduction in the ability of VAN clients to utilize their own data flowing from the VAN for order fulfillment for example.

Numerous other prior art systems, software and methods are directed at providing relatively complex computer-implemented solutions for transacting business electronically which are all adopted by an entire group of electronic trading partners but do not involve the use of a VAN. Many of such solutions are provided in accordance with an Application Service Provider (“ASP”) model. Implementation of such prior art solutions requires each of the members of such group to migrate to new hardware/software resulting in a number of disadvantages. First, there is the loss of convenience of using hardware/software with which such members are already familiar. Second, there is the added cost of the new hardware/software. Third, there are the training costs related to training personnel for the use of such new hardware/software. Fourth, there are implementation costs related to integrating such new software with other systems, etc. Fifth, and perhaps most importantly, such prior art solutions often require members of such group to adopt new business processes rather than take advantage of the inherent efficiencies that will likely result from continuing to utilize existing business processes. Sixth, in an implementation of such prior art solutions between buyers and suppliers of goods or services, suppliers are generally permitted only to sign on to the ASP and view the electronic data. Such prior art solutions do not generally permit a supplier to sign on to the ASP, view the electronic data, and also process the electronic data. Seventh, such prior art solutions result in significant ongoing operation costs, including but not limited to infrastructure costs.

It should be understood, that the sixth advantage listed above is particularly inconvenient for a supplier who is a manufacturer. Electronic data generated, or transferred, by the ASP, for example a sales order, is important for the manufacturer to conduct its own supply chain management.

An example of systems or services in accordance with this ASP model are the systems and services of ARIBA™.

Still other related prior art solutions are directed at particular means for translating electronic transaction data from one format to another. For example, U.S. Pat. No. 4,951,196 issued on Aug. 21, 1990 to Supply Tech, Inc., discloses a programmable machine system and method for performing electronic data interchange among a variety of trading partners. The programmable machine system according to the preferred embodiment of this prior art invention includes an input means for defining a dictionary-structured transaction format that has a plurality of elements in a particular organization. Provision is made for selecting a particular system component such as a printer, screen or the like which is typically not well suited for using the dictionary-structured format to interface with a human operator. An overlay generator generates an overlay that includes a second format associated with the selected system component. The second format has elements or fields that are related to the elements in the dictionary-structured format. The overlay generator also generates mapping between the related elements of the two formats. Data that are entered in the second format are translated into the dictionary-structured format so that they can be later transmitted in the format to a trading partner. Also, data received in a dictionary-structured format from a trading partner can be translated into the second format.

Still other prior art solutions are directed at systems, computer products or methods for transacting business electronically between a number of electronic trading partners using different data formats. In particular, a prior art solution is known for permitting different accounting software systems to communicate electronically via a universal file format. This invention is disclosed by the EC Company of Palo Alto, Calif. who is the owner of U.S. Pat. No. 5,794,234 which issued on Aug. 11, 1998. The electronic distributed system of this invention contains a secure network providing restricted access to an electronic commerce trading group that comprises certain client computers and at least one network server. The client computers represent one or more trading partners and/or banking institutions that communicate with each other in order to efficiently process business and financial data that represent EDI and EFT type transactions. Each of the client computers stores its data in an accounting database incorporating a data format that is incompatible with one or more of its trading partners. Since several different data formats can be utilized, a universal data format is used to transmit data between each computing system connected to the network, therefore a means for translating such data to the universal data format. The universal file format is a freestyle format that accommodates any data element associated with a particular trading partner's accounting database without regard to a predefined order. Transmitted data is converted from the format of the accounting database to the universal file format in order to transmit the data to a trading partner and/or institution. The received data is then converted from the universal file format to an appropriate format of the destination client computer. However, it is clear from the disclosure of this prior art invention that each client needs be provided with specific network elements to communicate with the electronic distributed system of the this prior art invention.

Thus, there is a need for a system, a computer product and a method for transacting business electronically that is easy to implement, including throughout a relatively large group of electronic trading partners using a variety of systems, computer products and methods of transacting business electronically. There is a further need for a system, a computer product and a method for transacting business electronically that adapts to the system or electronic form requirements of electronic trading partners utilizing such system, computer product and method.

### SUMMARY OF THE INVENTION

In a first aspect of the invention a system is provided for conducting business electronically between a plurality of computers corresponding to a plurality of users through an interconnected network of computers, said system being adapted to send data to and receive data from said plurality of computers, said system comprising; a server computer connected to said interconnected network of computers, said server computer comprising a data exchange means, wherein said data exchange means provides a means for receiving and processing instructions corresponding to business rules corresponding to each of said plurality of users; a means for mapping data transactions; a means for translating data transactions from and to a plurality of electronic formats; a data transaction repository for receiving and processing instructions for deployment of data transactions; and an electronic commerce means for processing data transactions, said electronic commerce means being responsive to said data transaction repository and the business rules so as to process data transactions in accordance with said business rules.

In a second aspect of the invention a computer product is provided for installation on a server computer for conducting business electronically between a plurality of computers corresponding to a plurality of users through an interconnected network of computers, said system being adapted to send data to and receive data from said plurality of computers, said computer product comprising: a server computer product adapted to facilitate communication between said server computer and an interconnected network of computers, said server computer product comprising a data exchange means, wherein said data exchange means cooperates with a database to provide: a means for receiving and processing instructions corresponding to business rules corresponding to each of said plurality of users; a means for mapping data transactions; a means for translating data transactions from and to a plurality of electronic formats; a data transaction repository for receiving and processing instructions for deployment of data transactions; and an electronic commerce means for processing data transactions, said electronic commerce means being responsive to said data transaction repository and the business rules so as to process data transactions in accordance with said business rules; and a facility for storing data generated by said data exchange means to said database.

In a further aspect of the invention a system is provided for conducting business electronically between a plurality of computers corresponding to a plurality of users through an interconnected network of computers, said system being adapted to send data to and receive data from said plurality of computers, said system comprising: a server computer connected to said interconnected network of computers, said server computer comprising a data exchange means, wherein said data exchange means provides: a means for receiving and processing instructions corresponding to business rules corresponding to each of said plurality of users; a means for mapping data transactions; a means for translating data transactions from and to a plurality of electronic formats; a data transaction repository for receiving and processing instructions for deployment of data transactions; and an electronic commerce means for processing data transactions, said electronic commerce means being responsive to said data transaction repository and the business rules so as to process data transactions in accordance with said business rules; wherein said data exchange means and database are integrated so that data flows freely between said data exchange means and database. In a still other aspect of the invention a method is provided of implementing an electronic community adapted to permit a plurality of users to exchange business electronically, said method comprising the steps of: determining the business rules of said plurality of users; customizing a data exchange means in accordance with said business rules, said data exchange means comprising: a means for receiving and processing instructions corresponding to business rules corresponding to each of said plurality of users; a means for mapping data transactions; a means for translating data transactions from and to a plurality of electronic formats; a data transaction repository for receiving and processing instructions for deployment of data transactions; and an electronic commerce means for processing data transactions, said electronic commerce means being responsive to said data transaction repository and the business rules so as to process data transactions in accordance with said business rules; providing access to the data exchange means to said plurality of users through an interconnected network of computers.

In still a further aspect of the invention a method is provided of implementing an electronic community adapted to permit a plurality of users to exchange business electronically, said method comprising the steps of: determining the business rules of said plurality of users; customizing a data exchange means in accordance with said business rules, said data exchange means comprising: a means for receiving and processing instructions corresponding to business rules corresponding to each of said plurality of users; a means for mapping data transactions; a means for translating data transactions from and to a plurality of electronic formats; a data transaction repository for receiving and processing instructions for deployment of data transactions; and an electronic commerce means for processing data transactions, said electronic commerce means being responsive to said data transaction repository and the business rules so as to process data transactions in accordance with said business rules; providing access to the data exchange means to said plurality of users through an interconnected network of computers; and customization of the data exchange means so as to permit each of said plurality of users to access data generated by said data exchange means in accordance with user requirements by means of a custom interface.

### BRIEF DESCRIPTION OF THE DRAWINGS

A detailed description of the preferred embodiment(s) is(are) provided herein below by way of example only and with reference to the following drawings, in which:

FIG. 1 is a system flowchart illustrating the resources of the system of the present invention.

FIG. 2 is a computer program resource flowchart illustrating the program resources of the computer product of the present invention.

FIG. 3 is a flowchart illustrating the steps required for an electronic trading partner to implement the system of the present invention.

FIG. 4 illustrates a representative group of data transactions processed by the system and computer product of the present invention.

FIG. 5 illustrates a representative set of reports generated by a supplier by means of the system and computer product of the present invention.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

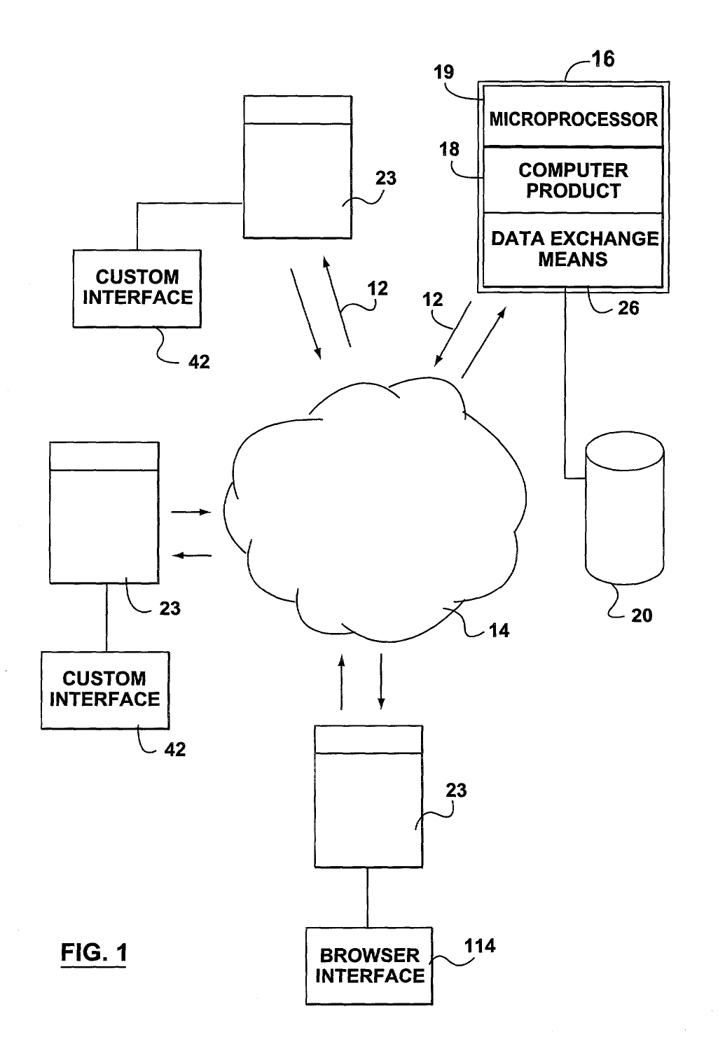

Referring to FIG. 1, there is illustrated a system resource flowchart illustrating the resources of the present system, in an illustrative implementation of same in the environment of multiple electronic trading partners. One advantage of the present invention is that it enables a plurality of such electronic trading partners to transact business electronically with minimal set-up barriers. A group of such entities transacting business electronically with one another is referred to in this disclosure as a Data Exchange Group. An individual entity within a Data Exchange Group is referred to in the disclosure as a Data Exchange Member.

In accordance with the present invention, each Data Exchange Member has their own computer systems running their own software, located at a Data Exchange Server Farm or Data Exchange Member Computer 23. It should be understood that Data Exchange Server Farm 23 may comprise any manner of computer systems and software as may be required by a particular Data Exchange Member. It may comprise a server computer linked to a web server in a manner that is well known, a personal computer or a WAP device.

In either case, such computer systems shall permit connection to an interconnected network of computers 14 by means of a network connection 12. In the preferred embodiment of the present invention, the network environment of the interconnected network of computers 14 is the Internet. This is to take advantage of the cost efficiencies that are inherent in transacting business electronically via the Internet rather than a VAN, for example. Therefore, as further explained below, the various utilities described in this disclosure that form part of the system and computer product of the present invention are web-enabled. However, as disclosed below, the present invention also provides means for transacting business electronically via existing VAN connections between a Data Exchange Member and a VAN.

The system of the present invention includes a server computer 16, having its own network connection 12. The hardware comprising server computer 16 is provided in a manner that is well-known. The computer product 18 of the present invention resides at server computer 16.

Said server computer 16 is provided in a manner that is well-known and includes a microprocessor 19 and database 20. For example, the server computer 16 is provided by a plurality of web servers, active directory servers, database servers, commerce servers, exchange servers, and communication servers, in a manner that is well known. Database 20 is best understood as a data centre, as is explained below

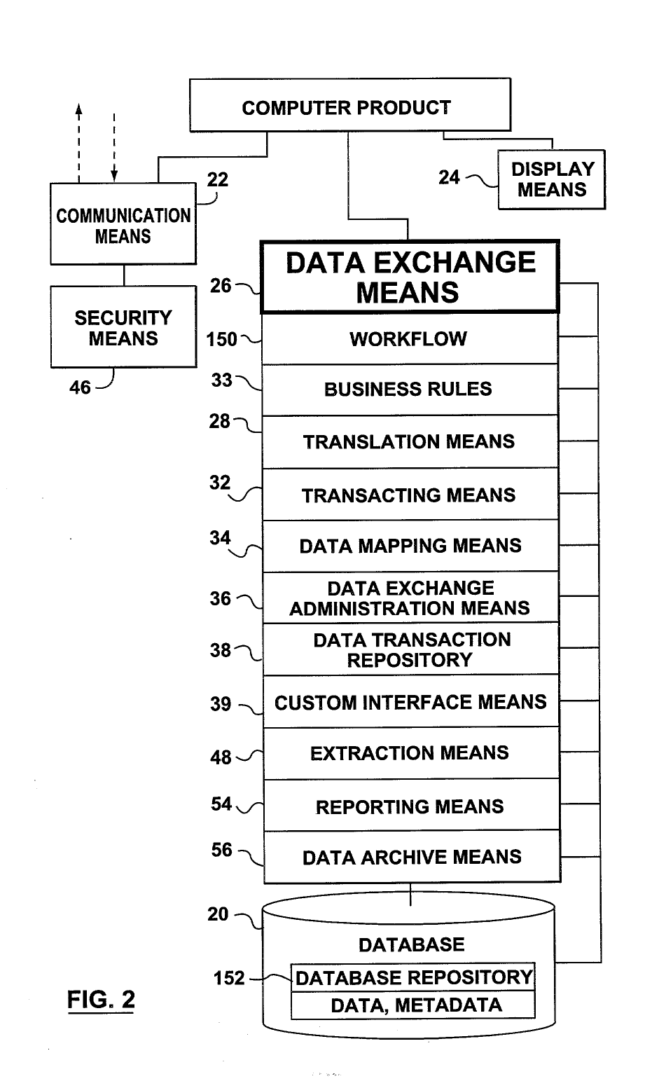

The computer product 18 of the present invention is installed on the server computer 16. Also, as best shown in FIG. 2, the computer product in co-operation with said server computer 16 provides a communication means 22; display means 24; and data exchange means 26.

Said communication means 22 provides means for the various Data Exchange Members forming a Data Exchange Group to communicate with server computer 16 and thereby access the features thereof described in this disclosure via Data Exchange Server Farm 23, or another computer device such as a personal computer or WAP device. Communication means 22 in this way provides means for either wired or wireless communication with server computer 16 in a manner that is well-known. As is best understood by referring to the explanation of the display means 24 below, the communication means 22 provides means for transferring data to, and receiving data from, the data exchange means 26 also described below by flat files such as e-mail or FTP (File Transfer Protocol) for transfer and receipt via the Internet. The communication means 22 also provides means for creating direct interfaces between the data exchange means 26 and the computer systems of various Data Exchange Members, for example, by means of secure VPN's (Virtual Private Network) or existing VAN connections, in co-operation with such intersystem communication methods such as SOAP, XML, Message Queuing, HTTP/HTTPS, SMTP, Direct COM interfaces and the like. All such interfaces are provided in a manner that is well-known.

The display means 24, as illustrated below, provides means for accessing and retrieving data from database 20 of the present invention in the form of batches of electronic data or electronic transactions as explained below. Said display means 24 also allows a variety of batches of electronic data or electronic transactions to be displayed for permitting Data Exchange Members to submit data to server computer 16 for the purpose of transacting business electronically.

As best shown in FIG. 2, the data exchange means 26 of the present invention is best understood as an integrated application repository comprising a series of utilities required by Data Exchange Members to transact business electronically. The data exchange means 26 in turn is fully integrated with database 20 which comprises a database repository 152 of data relevant to each of said Data Exchange Members. Data exchange means 26 is best understood as an application repository of integrated software utilities designed in accordance with “Open Standards” so as to provide a scaleable modular architecture permitting additional software utilities to be added to respond to the advent of new electronic commerce standards (such as data transactions) or Data Exchange Group requirements. The particular embodiment of the data exchange means 26 of the present invention is deployed on Microsoft Windows .NET™ architecture, however, it is within the scope of the present invention to implement the data exchange means 26 utilizing other software utilities.

comprises a translation means 28 (or “Universal Translator Engine”) for translating incoming data transactions to said data exchange means 26. The data exchange means 26 further comprises a transacting means 32 which cooperates with said microprocessor 19 and database 20 to access and process the data transactions as described below.

Said translation means 28 is adapted to recognize data transactions of a variety of electronic transactions. The translation means 28 is implemented in accordance with “Open Standards” software development methods in accordance with a scaleable and open modular software architecture. In this way, the translation means 28 of the present invention is easily enhanced to be responsive to new standards of data transactions, including existing custom data transactions utilized by particular Data Exchange Groups, or particular Data Exchange Members within one such particular Data Exchange Group.

As illustrated by the example of the present invention in operation below, the translation means 28 of the present invention provides means for Data Exchange Groups to transact business electronically without having to migrate to new data transactions, having to invest in expensive translators to permit communication with a prior data exchange means, having to integrate such translators with existing computer systems, or having to adopt new data transactions.

Also as best shown in FIG. 2, the data exchange means 26 of the present invention further comprises a data mapping means 34 for mapping data received from Data Exchange Groups by the server computer 16 of the present invention for processing by the transacting means 32 as further described below. As is well known in the art, mapping comprises a form of electronic tagging of individual data packets that permits particular electronic data to move through the correct electronic business cycle (as further explained below) and also permits the tracking of the electronic business cycle in its various stages.

Data mapping means 34 is also adapted to map outgoing data transactions in accordance with specific data mapping required for the data transactions to be processed by the computer systems of Data Exchange Members in accordance with their respective business rules.

The data exchange means 26 of the present invention handles a number of electronic data transaction standards such as X12, XML, EDIfact, or ebXML standards.

Also as best shown in FIG. 2, data exchange means comprises means for inputting and receiving the business rules 33 of each Data Exchange Member. These business rules 33 relate to a plurality of matters including the form in which data is sent to data exchange means 26; the form in which data is sent by data exchange means 26 to other Data Exchange Members; the particular data transactions transacted as between a particular Data Exchange Member and other Data Exchange Members; (as explained below) the particular data processing requirements of Data Exchange Members in regard to data generated by the data exchange means 26. The operator of server computer of the present invention determines the particular workflow 150 for conducting the electronic business cycle of a particular Data Exchange Group.

The transacting means 32 of the present invention is best understood as an electronic commerce engine. Said transacting means 32 is associated with database 20 and is further associated with data transaction repository 38, business rules 33 and workflow 150. The data transaction repository 38 contains the particular type and sequence of data transactions processed by the transaction means 32. Together, the transacting means 32, workflow 150, business rules 33, and data transaction repository 38 comprise the instructions necessary to process the particular electronic business cycles of a particular Data Exchange Group. The data exchange repository 38 is provided in a manner that is known to those skilled in the art. The actual data transactions generated by transacting means 32 are then stored to the Database Repository 152.

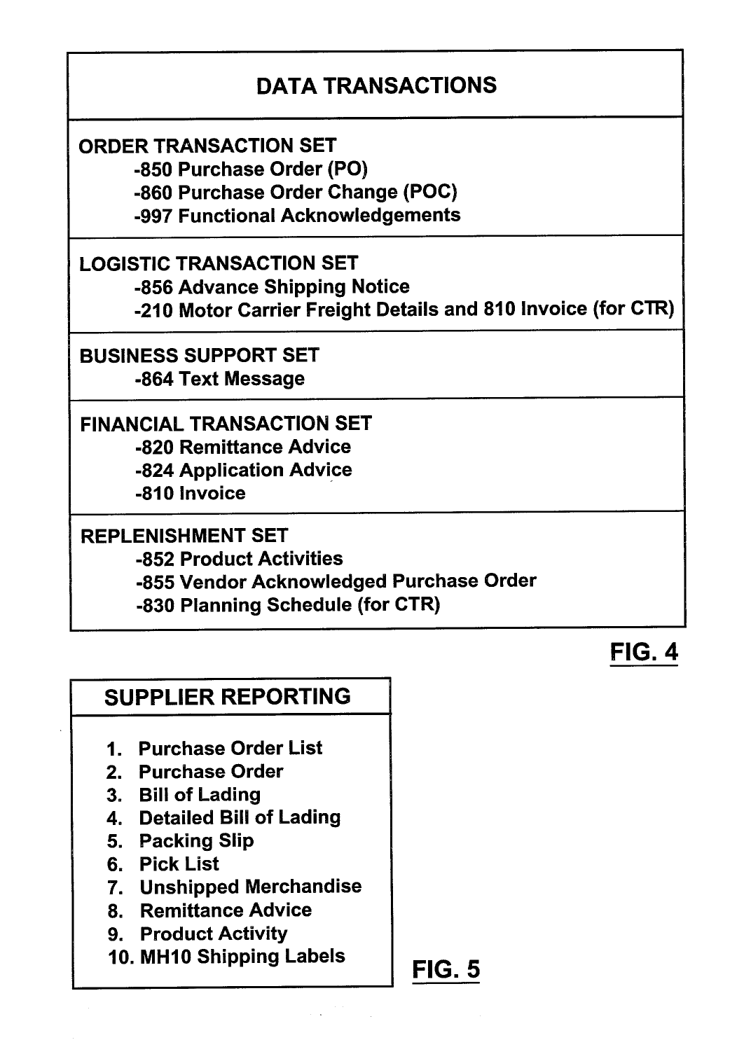

An example of a particular set of such data transactions corresponding to a particular Data Exchange Group is illustrated in FIG. 4. Generally speaking such data transactions comprise a series of electronic transactions required to transact business electronically. FIG. 4 illustrates data transactions in a particular business environment, namely the retail sales environment. The content and form of such particular data transactions will depend in some cases on the particular business of the Data Exchange Group or individual Data Exchange Members of a particular Data Exchange Group, as is well known to those engaged in logistics management or supply chain management. Generally, such data transactions will comprise a series of sets related to Electronic Data Interchange (“EDI”) or other similar electronic commerce standards.

Also as illustrated in FIG. 4, examples of such EDI sets comprise Order Transaction Sets (e.g. a Purchase Order), Logistics Transaction Sets (e.g. an Advance Shipping Notice), Financial Transaction Sets (e.g. an Invoice) and Business Support Transaction Sets (such as data transactions permitting a buyer to communicate customer price ticket information to specific sellers), and Replenishment Sets (e.g. Product Activities sets permitting buyers to communicate on-hand inventory quantity, sales quantity and returned quantity). It should be understood that the present invention is provided in a manner that permits the change of said data transactions including the addition of new types of data transactions.

It should be understood, however, that the present invention contemplates use of other data transactions as are used in the financial services industry, for example, which are provided in a manner that is well known. Implementation of such data transactions within the present invention by defining the business rules 33 and data transaction repository 38 in compliance with such financial services industry transactions is also well known.

Specifically in regard to such electronic transactions, it should be understood that the transacting means of the present invention has been provided in a manner that is easy to deploy. In particular, the data capture effort during workflow is reduced because said data exchange means 26 binds electronic transactions to the data comprising such electronic transactions dictated by the particular data transactions. In this way, the electronic transactions themselves are processed in each workflow business cycle. This particular feature of the transacting means improves efficiency in processing of such electronic transactions, and more importantly reduces processing errors that can result in delays and expensive problem resolutions.

The present invention also comprises a data exchange administration means 36 which is operably associated with the display means 24, microprocessor 19 and database 20 to administer hierarchical access provided to the system of the present invention to particular Data Exchange Groups or particular Data Exchange Members within a particular Data Exchange Group. In particular, data exchange administration means 36 allows administration of security, membership profiles and preferences, in a manner that is well-known. It should be understood that said data exchange administration means 36 also provides means for automated administration of security, membership profiles and preferences by defined users of a particular Data Exchange Group, within specific parameters. Particularly in the implementation of the present invention where a Data Exchange Group has numerous Data Exchange Members who are required to implement the system of the present invention, this automated administration provided by said data exchange administration means 36 is desirable.

Display means 24 of the present invention provides means for sending and receiving data from said data exchange means 26 from more than one interface, depending on the particular requirements of various Data Exchange Groups or particular Data Exchange Members of such Data Exchange Groups, as best shown in FIG. 4. In the preferred embodiment of the present invention, said display means 24 provides both a custom interface 42 and a browser interface 44.

In the particular embodiment of the custom interface 42, a customized web portal is provided. The custom interface 42 provides means for Data Exchange Members to access data at Data Exchange Means 26 and also to process said data remotely. The custom interface 42 is customized in that data exchange means 26 provides means for processing said data, as described above, in accordance with particular business rules applicable to a particular Data Exchange Member. These particular business rules are also entered into the data transaction repository 38 described above. The particular business rules may relate, for example, to particular rules for fulfillment of a particular data transaction such as a Purchase Order received by a Data Exchange Member who is a supplier, from another particular Data Exchange Member who is a buyer. For example, in operation, the Data Exchange Member who is a supplier may reject Purchase Orders from the particular Data Exchange Member who is a buyer, unless particular information is provided in the Purchase Order. Another aspect of the customer interface 42 is that the particular Data Exchange Member who is a supplier may deal with 3^{rd} party warehouses in the fulfillment of Purchase Orders, for example. The particular business rules, therefore, may require that the Purchase Order be sent to such 3^{rd} party warehouses, with certain information such as cost prices, automatically blocked out, if the Data Exchange Member who is a supplier does not wish to share this information with such 3^{rd} party warehouses.

In another example of the operation of the custom interface 42, a particular Data Exchange Member who is a supplier may wish to use the data received by means of a plurality of Purchase Orders to pick and pack the items described in such plurality of Purchase Orders and create an electronic Advanced Shipping Notice. In prior art solutions, the creation of such an Advanced Shipping Notice would occur manually. The present invention, however, permits data transactions received from the data exchange means 26 to be used to generate further data transactions (not shown) responsive to such data transactions, such as for example an Advanced Shipping Notice responsive to one or more Purchase Orders. Furthermore, custom interface 42 can be provided, in a manner that is well known, to interface with other systems of the Data Exchange Member who is a supplier, such as scanning and labeling equipment that permits, in association with the custom interface 42 and data exchange means 26, an Advanced Shipping Notice to be created automatically in response to scanning of a container label, and uploading of the resultant data to the Internet through the custom interface 42.

In yet another embodiment of the custom interface 42, a first Data Exchange Member (in this example a supplier) is permitted by custom interface 42 to operate a catalogue of previous picking/packing information for a particular other Data Exchange Member (in this example a buyer). The particular business rules of the buyer may not be up to date as to the buyer's particular picking/packing requirements. As between the buyer and the supplier, failure to respect such particular picking/packing requirements may result in returns of products from the buyer to the supplier. Rather than rely on the currency of data dependent on the business rules of the buyer, supplier may through custom interface 42 operate an on-line catalogue that provides up to date picking/packing information for the buyer, and other Data Exchange Members, for example by correlating such on-line catalogue with recent returns made by the buyer. In this way, up to date default picking/packing parameters can be selected by employees of the supplier. The above functionality is readily provided by a person skilled in the art by application of ordinary knowledge to the implementation of the invention disclosed herein.

It should be understood that numerous business rules can be provided to the data transaction repository 38, as is well known, and thus the specific functions of the custom interface 42 will vary accordingly. In each case, however, the custom interface 42 provides means of processing data accessed by means of the custom interface 42, as illustrated in the examples provided above.

In the particular preferred embodiment of the browser interface 44, a browser-based EDI-enabled secure web portal application is provided which permits Data Exchange Members to access the features of the data exchange means 26 with no more than a web browser, whether run on a personal computer, WAP or other device including a microprocessor. The provision of both the custom interface 42 and browser interface 44 permits the present invention to be deployed with minimal barriers to entry such as infrastructure costs, integration costs etc. The browser interface 44 in particular is desirable for including in a Data Exchange Group a large number of smaller supplier or customer, for example.

The data exchange means 26, communication means 22, and display means 24 of the present invention co-operatively provide a security means 46 for encouraging data security in relation to the operation of the present invention. Said security means 46 is best understood as a series of hardware, system software and application security tools, which are well known and implemented in a manner that is also known. First, as mentioned above, data exchange means 26, depending on the particular requirements of Data Exchange Members, transmits and receives data by means of a VPN on an encrypted basis. Second, display means 24 ensures that access to the system of the present invention is only granted to Data Exchange Members providing valid authentication data such as a private identification number and password combination. Such authentication data is assigned to particular Data Exchange Members by means of data exchange administration means 36, as explained above. Third, the display means 24, and particularly the browser interface 44 utilizes the well known Secure Sockets Layering (SSL) which secures traffic from and to Data Exchange Members using the browser interface 44. SSL server authentication typically allows users to confirm a web server's identity so that the user can have confidence in the system. SSL-enabled client software, such as a Web browser, can automatically check that a server's certificate and public identification data are valid and have been issued by a certificate authority such as Verisign™ listed in the client browser's list of trusted certificate authorities. Fourth, within the preferred embodiment of the data exchanging means 26, IPSEC is in use between the system of the present invention and Data Exchange Members utilizing VPN to secure bulk data that is transferred into said data exchange means 26, as described above. IPSEC, as is well-known is a security standard defined by IETF for IP network layer security allowing end-to-end encryption and authentication thereby rendering TCP/IP communications secure for use in both public and private computer networks. Fifth, again within the preferred embodiment of the date exchange means 26, the security features of the Windows 2000™ NT platform support PKI (Public Key Infrastructure) by means of a Certificate Server that allows Data Exchange Members to issue their own certificates to other Data Exchange Members for PKI functionality such as certificate-based authentication, IPSEC, secure email and so forth, in a manner that is well-known to those skilled in the art.

Also, said Windows 2000™ NT platform comprises an Active Directory providing capability to enable role-based hierarchical secure usage scenarios whereby a Data Exchange Member is given a certificate that allows them to gain specialized, secure access to pre-determined parts of the system of the present invention. Sixth, as best shown in FIG. 1, the data exchange means 26 of the present invention is provided in association with a De-Militarized Zone, namely a system area protected by a first firewall 50 protecting the Extranet application layer, and a second firewall 52 protecting the production layer, also in a manner that is well-known.

Data exchange means 26 further comprises an extraction means 48 which presents means for extracting data from said data exchange means 26 to a variety of devices related to the data transactions underlying the electronic business cycle described herein, for example, container labels bearing barcodes. Such labels are provided by means of electronic labels created by said data exchange means 26, for example in HTML or Adobe Acrobat™ files, in a manner that is well known.

The data exchange means 26 further comprises a reporting means 54 which is provided in association with said communication means 22 and display means 24 so as to provide a number of reports to Data Exchange Members with respect to the electronic business cycle conducted by the data exchange means 26. As best shown in FIG. 5, examples of such reports, again from the illustrative retail sales environment, include a Purchase Order List (lists available purchase orders, transaction type, ship to location, number of items, quantity ordered); Bill of Lading (list contents of shipment and other pertinent data); Packing Slip; Pick List (lists items picked from inventory); Product Activity (reports actual sales and inventory on-hand, for example, for each buying store or region); Supplier Fulfillment Activity (number of products shipped by Supplier, product, time, etc.), in a manner that is well-known. It should also be understood that reporting means 54 provides means of searching and accessing particular reports in accordance with numerous search parameters defined by the data included in such reports, for example, transaction type, supplier identification data, order date range etc. Again, as explained herein, display means 24 provides means for Data Exchange Members to access and process such particular reports in accordance with their own business rules, in association with reporting means 54.

The database 20 of the present invention also provides in co-operation with data exchange means 26 a data archive means 56 of transactions processed by said transacting means 32, in a manner that is well-known. In the particular preferred embodiment of the present invention, the archive files provided to the database 20 comprises a copy of each transaction data file with a date and timestamp.

The present invention further comprises an audit and control means 58 to ensure that all data transactions within the system are verified and validated. This is provided by means of system and activity logging in cooperation with the reporting means 54. In addition, process flow controls are implemented within the data exchange means 26 to identify and escalate problem resolution with respect to unsuccessful electronic transactions.

The present invention is best understood by illustration of an example in operation. The example provided illustrates the implementation of the present invention in a particular environment, namely a Data Exchange Group in the retail sales environment, and also processing of an electronic business cycle within such Data Exchange Group. It should be expressly understood that the present invention is directed at all market sectors and the retail sales environment is used for the purposes of one illustrative example only.

In the retail sales environment, as is often the case more generally, the average Data Exchange Group will comprise a large number of suppliers, service providers (such as carriers) and customers (where certain customers also desire to conduct business electronically). All of such Data Exchange Members will generally have different computer systems, using different software, having different business rules, and having individual users of varying degrees of experience in using computers. Some of such Data Exchange Members may also have existing business processes and technologies for conducting business electronically, including established relationships with VANs, for example.

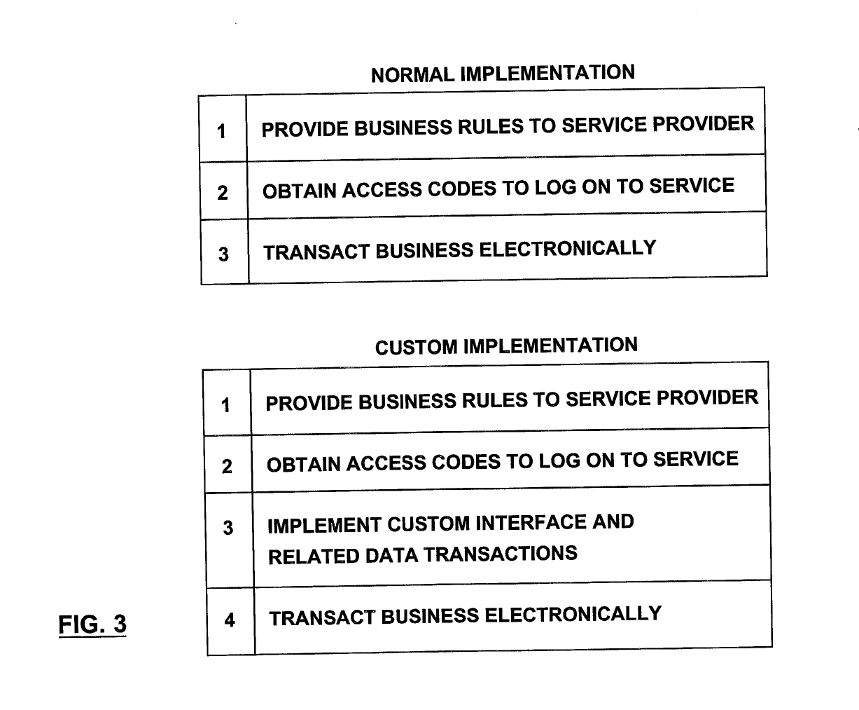

The method of the present invention is best understood by reference to FIG. 3.

The method of the present invention is therefore best understood as a method of implementing computer-based supply chain management in accordance with the steps illustrated in FIG. 3. This method comprises both a “Normal Implementation” wherein the browser interface 44 is employed; and a “Custom Implementation” wherein the custom interface 42 is employed. One of the advantages of this method is the absence of the requirement of the implementation or use of a data translation engine or data mapping engine independent of data exchange means 26 of the present invention. This is because the data translation and data mapping is conducted by the data exchange means 26, as explained above. Furthermore, for the reasons also explained above, implementation of the method of the present invention also provides access to Data Exchange Members to the data provided to database 20, including data processed by means of data exchange means 26 on a remote basis.

The first step in the method described herein is determining the cumulative business rules of a Data Exchange Group by defining their cumulative requirements for conducting business electronically. These business rules are used to customize the transacting means 32 of the present invention so as to provide means for executing each of such cumulative requirements for conducting business electronically.

The second step in the method described herein is providing access to the data exchange means to the Data Exchange Members within the Data Exchange Group by means of the data exchange administration means 36 and display means 24 of the present invention. For example, in the case of a Data Exchange Member who is a supplier, such Data Exchange Member will be assigned logon identification data, the responsibilities of such Data Exchange Member will be assigned (e.g. user, technical contact, EDI contact, etc.). the parameters of the relationship of the Data Exchange Members with respect to other Data Exchange Members is defined, including access to other Data Exchange Members and Data Exchange Group data collected within the system of the present invention. In most cases, confirmation of the profile of the Data Exchange Member determining the previously mentioned parameters will be required from one or more other Data Exchange Members forming part of the Data Exchange Group.

The third and last step under the “Normal Implementation” comprises transacting business electronically by means of the system and software of the present invention.

In accordance with the “Custom Implementation”, the method of the present invention further comprises an additional step of implementing the custom interface 42. This requires customization of the date exchange means 26 of the present invention wherein the particular system, security, electronic standard or data communication parameters of a Data Exchange Member are not currently accommodated by the data exchange means 26.

Depending on whether such particular parameters exist, the Data Exchange Group, according to the present invention, by means of the method described above is able to conduct business electronically. As described above, this is permitted in accordance with the particular structure and functions of the data exchange means 26.

Once the Data Exchange Group is able to conduct business electronically in accordance with the present invention, the Data Exchange Group is ready to process an electronic business cycle. In accordance with the particular example in operation of a retail sales environment, a representative electronic business cycle is best understood as comprising a buyer processing cycle and supplier processing cycle, wherein each of the buyer processing cycle and supplier processing cycle comprises an external process (processing conducted by the computer systems of the buyer and supplier) and internal system process (processing conducted by the system of the present invention).

A representative external buyer process includes one or more of the following transactions directed at the buyer's suppliers: Planned Order Forecast, Purchase Order, Purchase Order Change and Acknowledgment.

A representative internal system process responsive to said representative external buyer process includes one or more of the following transactions: Data Archiving (by means of said data archive means 56); Data Translation (by means of said translating means 28 whereby said incoming data transactions are translated to the system common format and said mapping means 34 maps the incoming data transactions; Data Validation (to validate the data contained in such incoming data transactions for correct transmission information, for example, correct identification data for one of the suppliers of the buyer transmitting the incoming data transaction); Data Load (whereby the information contained in the incoming data transaction is loaded to database 20 so as to permit transacting means 32 to process the requisite electronic business transactions responsive to the incoming data transactions); Acknowledgments (for transmission in association with the communication means 22 to the buyer to acknowledge receipt of the incoming data transactions.

In response, the supplier processing cycle will be initiated. Depending on the particular means with which a particular supplier accesses the system of the present invention, initiation will be either automatic, or dependent on the particular supplier accessing the system of the present invention in cooperation with display means 24, as described above.

Once the supplier processing cycle is initiated, the supplier will review product demand and re-order estimate. The supplier will then navigate directly to Purchase Order or open a list of outstanding tasks. Once a Purchase Order is ready to fulfil, the supplier will choose Purchase Order to ship. The supplier will then complete the ASN, including with shipment date, packaging date, carrier information, trailer information, and so on. In turn, the supplier generates an inventory pick list. Next, the supplier generates and prints shipping labels in association with extraction means 48. After packing is complete, the supplier fills in a request for pick-up or delivery. This request is sent to the buyer. Then, the buyer returns the scheduled pick-up date. The supplier views the schedule pick-up date. Following this, the supplier issues an ASN, which is sent by the system of the present invention to the buyer. The supplier can then view the ASN and revise information, if necessary. Next, the supplier chooses shipment to bill and generates and sends the product and/or freight invoice. Lastly, the buyer transmits remittance advice which is acknowledged by the system and the supplier reviews payment details.

It should be understood that the provision of certain services may be provided in addition to the processing of electronic data transaction described herein, where the system described herein facilitates the ordering and provision of such services. Such services include providing wireless messaging and related services, certain paper-based transactions or back-up as well as a complete EDI solution for suppliers who use fax or electronic mail.

It should be understood that the system, computer product and method with data exchange means 26 described herein permits data to flow within such system incorporating the data exchange means 26 freely, independent of data standards, forms being used, mapping requirements or business processes of particular Data Exchange Members. This is because the data exchange means 26, database 20 and display means 24 which comprises the front end of the present invention are fully integrated. The components of the computer product described are managed and architected in a manner that is known to a skilled software architect so that input and output of data throughout the components, and as described above, is fully integrated. As stated earlier, data exchange means 26 in this way permits the various Data Exchange Members to access data generated by data exchange means 26, and in accordance with the business processes of the Data Exchange Members, and stored in database 20 without the need for their own data mapping means or data translating means. The fact that said components are fully integrated and data flows freely within the system disclosed herein permits database 20 to be provided so that Data Exchange Members have access to “rich” data, in accordance with their needs implemented in the system described by means of business processes. This access to “rich” data combined with the flexibility of the system of the present invention, permits Data Exchange Members to derive maximum benefit from the use of their own data, for example, in automation of business processes.

The present invention provided other benefits, including savings in infrastructure costs amongst the various Data Exchange Members. These infrastructure costs relate not only to hardware, software and business process implementation costs upon installation of the various Data Exchange Members on the data exchange means 26, but also on a moving forward basis in view of the ability of the data exchange means 26 to incorporate new hardware and software technologies, as well as new business processes required by the ongoing needs of various Data Exchange Members.

Other variations and modifications of the invention are possible. For example, numerous other features can be added to the present invention without departing from the spirit of the invention. These include support of different electronic standards, network connections, data security utilities, particular system architectures also supporting the functions described herein, further reporting utilities, disaster recovery utilities, back-up utilities, electronic payment of various electronic transactions, automated problem resolution, help-desk resolution including automated initiation of help-desk response, online FAQ's and the like. In addition, alternate computer systems, enhancements or hardware configurations can be used in providing the system described herein. All such modifications or variations are believed to be within the sphere and scope of the invention as defined by the claims appended hereto.

We claim:

1) A system for conducting business electronically between a plurality of computers corresponding to a plurality of users through an interconnected network of computers, said system being adapted to send data to and receive data from said plurality of computers, said system comprising:
a) a server computer connected to said interconnected network of computers, said server computer comprising a data exchange means, wherein said data exchange means provides:
i) a means for receiving and processing instructions corresponding to business rules corresponding to each of said plurality of users;
ii) a means for mapping data transactions;
iii) a means for translating data transactions from and to a plurality of electronic formats;
iv) a data transaction repository for receiving and processing instructions for deployment of data transactions; and
v) an electronic commerce means for processing data transactions, said electronic commerce means being responsive to said data transaction repository and the business rules so as to process data transactions in accordance with said business rules.

2) A system as claimed in claim 1, said system further comprising a database for storing data generated by said data exchange means.

3) A system for conducting business electronically as claimed in claim 2, wherein said data exchange means comprises an application repository of integrated utilities said integrated utilities providing a means for receiving and processing instructions corresponding to business rules corresponding to each of said plurality of users; a means for mapping data transactions; a means for translating data transactions from and to a plurality of electronic formats; a data transaction repository for receiving and processing instructions for deployment of data transactions; and an electronic commerce means for processing data transactions, said electronic commerce means being responsive to said data transaction repository and the business rules so as to process data transactions in accordance with said business rules.

4) A system as claimed in claim 3, wherein said data exchange means is provided in accordance with an open standards architecture that permits deployment of additional utilities to said application repository.

5) A system as claimed in claim 4, wherein said server computer is responsive to data received from said plurality of computers regardless of the electronic format of such data; and wherein said server computer sends data to said plurality of computers in an electronic format understood by each of said plurality of computers.

6) A system as claimed in claim 5, wherein said server computer further comprises a display means for displaying data generated by said data exchange means to each of said plurality of users in accordance with the business rules corresponding to each of said plurality of users.

7) A system as claimed in claim 6, wherein said display means permits each of said plurality of users to access and process data generated by said data exchange means in accordance with the business rules corresponding to each of said plurality of users.

8) A system as claimed in claim 7, wherein said data exchange means further comprises a means for receiving and processing instructions defining an electronic workflow in said data exchange means, said electronic workflow corresponding to the electronic business cycle of each of said plurality of users.

9) A system as claimed in claim 8, wherein said data exchange means further comprises:
a) a security means for providing data security;
b) a data exchange administration means for automated administration of security, user profiles and preferences;
c) an extraction means for extracting data generated by said data exchange means from said database;
d) a reporting means for providing said plurality of users with reports based on said data generated by said data exchange means; and
e) a data archive means for extracting archive data from said database related to data transactions processed by said data exchange means.

10) A computer product for installation on a server computer for conducting business electronically between a plurality of computers corresponding to a plurality of users through an interconnected network of computers, said system being adapted to send data to and receive data from said plurality of computers, said computer product comprising:
a) a server computer product adapted to facilitate communication between said server computer and an interconnected network of computers, said server computer product comprising a data exchange means, wherein said data exchange means cooperates with a database to provide:
i) a means for receiving and processing instructions corresponding to business rules corresponding to each of said plurality of users;
ii) a means for mapping data transactions;
iii) a means for translating data transactions from and to a plurality of electronic formats;
iv) a data transaction repository for receiving and processing instructions for deployment of data transactions; and
v) an electronic commerce means for processing data transactions, said electronic commerce means being responsive to said data transaction repository and the business rules so as to process data transactions in accordance with said business rules; and
b) a facility for storing data generated by said data exchange means to said database.

11) A computer product as claimed in claim 2, wherein said data exchange means comprises an application repository of integrated utilities said integrated utilities providing a means for receiving and processing instructions corresponding to business rules corresponding to each of said plurality of users; a means for mapping data transactions; a means for translating data transactions from and to a plurality of electronic formats; a data transaction repository for receiving and processing instructions for deployment of data transactions; and an electronic commerce means for processing data transactions, said electronic commerce means being responsive to said data transaction repository and the business rules so as to process data transactions in accordance with said business rules.

12) A computer product as claimed in claim 11, wherein said data exchange means is provided in accordance with an open standards architecture that permits deployment of additional utilities to said application repository.

13) A computer product as claimed in claim 12, wherein said computer product is responsive to data received from said plurality of users regardless of the electronic format of such data.

14) A computer product as claimed in claim 13, wherein said computer product further comprises a display means for displaying data generated by said data exchange means to each of said plurality of users in accordance with the business rules corresponding to each of said plurality of users.

15) A computer product as claimed in claim 14, wherein said display means permits each of said plurality of users to access and process data generated by said data exchange means in accordance with the business rules corresponding to each of said plurality of users.

16) A computer product as claimed in claim 7, wherein said data exchange means further comprises a means for receiving and processing instructions corresponding to workflow in said data exchange means, said workflow corresponding to the electronic business cycle of each of said plurality of users.

17) A computer product as claimed in claim 16, wherein said data exchange means further comprises:
a) a security means for providing data security;
b) a data exchange administration means for automated administration of security, user profiles and preferences;
c) an extraction means for extracting data generated by said data exchange means from said database;
d) a reporting means for providing said plurality of users with reports based on said data generated by said data exchange means; and
e) a data archive means for extracting archive data from said database related to data transactions processed by said data exchange means.

18) A system for conducting business electronically between a plurality of computers corresponding to a plurality of users through an interconnected network of computers, said system being adapted to send data to and receive data from said plurality of computers, said system comprising:
a) a server computer connected to said interconnected network of computers, said server computer comprising a data exchange means, wherein said data exchange means provides:
i) a means for receiving and processing instructions corresponding to business rules corresponding to each of said plurality of users;
ii) a means for mapping data transactions;
iii) a means for translating data transactions from and to a plurality of electronic formats;
iv) a data transaction repository for receiving and processing instructions for deployment of data transactions; and
v) an electronic commerce means for processing data transactions, said electronic commerce means being responsive to said data transaction repository and the business rules so as to process data transactions in accordance with said business rules
wherein said data exchange means and database are integrated so that data flows freely between said data exchange means and database.

19) A method of implementing an electronic community adapted to permit a plurality of users to exchange business electronically, said method comprising the steps of:
a) determining the business rules of said plurality of users;
b) customizing a data exchange means in accordance with said business rules, said data exchange means comprising:
i) a means for receiving and processing instructions corresponding to business rules corresponding to each of said plurality of users;
ii) a means for mapping data transactions;
iii) a means for translating data transactions from and to a plurality of electronic formats;
iv) a data transaction repository for receiving and processing instructions for deployment of data transactions; and
v) an electronic commerce means for processing data transactions, said electronic commerce means being responsive to said data transaction repository and the business rules so as to process data transactions in accordance with said business rules.
c) providing access to the data exchange means to said plurality of users through an interconnected network of computers.

20)A method of implementing an electronic community adapted to permit a plurality of users to exchange business electronically, said method comprising the steps of:
a) determining the business rules of said plurality of users;
b) customizing a data exchange means in accordance with said business rules, said data exchange means comprising:
i) a means for receiving and processing instructions corresponding to business rules corresponding to each of said plurality of users;
ii) a means for mapping data transactions;
iii) a means for translating data transactions from and to a plurality of electronic formats;
iv) a data transaction repository for receiving and processing instructions for deployment of data transactions; and
v) an electronic commerce means for processing data transactions, said electronic commerce means being responsive to said data transaction repository and the business rules so as to process data transactions in accordance with said business rules.
c) providing access to the data exchange means to said plurality of users through an interconnected network of computers; and
d) customization of the data exchange means so as to permit each of said plurality of users to access data generated by said data exchange means in accordance with user requirements by means of a custom interface.
